(19) United States
(12) Patent Application Publication
(10) Pub. No.: US 2006/0046863 A1
(43) Pub. Date: Mar. 2, 2006

(54) Laser collimator for calibrating collimation of laser beams of a golf bar

(76) Inventor: Chung-Kai Yeh, Taipei Hsien (TW)

Correspondence Address: CHUNG-KAI YEH, 235 Chung-Ho, Box 8-24, Taipei, TW

(21) Appl. No.: 10/929,139

(22) Filed: Aug. 30, 2004

(51) Int. Cl. A63B 69/36; A63B 57/00; H01S 3/00

(52) U.S. Cl. 473/219; 372/38.02; 473/220; 473/208

(57) ABSTRACT

A laser collimator for calibrating collimation of laser beams of a golf bar comprises a discharge circuit including a capacitor and a resistor for controlling the discharging time; a switch; a digital circuit for generating preset and clearing actions so as to control the conduction and disconnection of current; the digital circuit being controlled by the switch; a boot type driving circuit for driving a following element; and a laser light emitter driven by the boot type driving circuit so as to illuminate; a transparent sheet being installed in front of the laser light emitting body; one surface of the transparent sheet being installed with a plurality of strips so that the laser beam from the laser light emitting body being as a straight beam. In using, as the switch is actuated, the laser light emitting body emits a straight beam for guiding a path of the golf ball so as to calibrate the pose of the user.

### FIELD OF THE INVENTION

The present invention relates to laser collimators, and particular to a laser collimator for calibrating collimation of laser beams of a golf bar, which emits laser light continuously without needing to press a switch continuously.

### BACKGROUND OF THE INVENTION

Currently, the laser beam from a laser collimator is a spot light, which is suitable for objects, such as laser beam or gun, for indicating a target. If the laser collimator is used in gun, not only the accuracy of the gun is increased greatly.

However, the prior art laser collimator is not effective as it is used in the golf bar, for example for the laser collimator used in a golf training field. In the prior art laser pen or laser collimator for calibrating the pose of a user, the button (for example, on an edge of a hat) for actuation a laser beam must be pressed continuously for emitting laser beam. However, the operation is inconvenient.

With reference to FIG. 1, a circuit for prior art laser collimator is illustrated. A switch P serves to conduct the circuit. The current flow through the discharge circuit formed by a resistor R1 and a capacitor C1. Then a transistor Q1 serves to drive a light emitting body D to light up. When the switch P is released, the circuit is disconnected so that the light emitting body D does not emit light. The operation of the prior art is illustrated in FIGS. 2 and 3.

In FIG. 2, the user presses the switch P continuously, the light emitting body D lights up. When the switch P is released, the circuit is disconnected. However, this makes a trouble to the user, since the user must press the switch continuously, as a result this work can not be performed continuously. For example for a speaker, the speaker can not take all the attentions to the speech

In FIG. 3, a laser collimator used in golf bar is illustrated. It is shown that a rod S is buckled to a hat edge T so as to light up a light emitting body D. The laser beam will target at a golf ball so that the user can know whether the poser is correct. However, all the current used laser collimator emits spot light. Those used the laser collimator are beginners. It is impossible for the beginner to aim at an object, but remain motionless, even to beat a golf ball into a hole. It is often that the switch P of the laser collimator is released so that light is extinguished. Thus the original object can not be achieved.

Thereby, the prior art has the following disadvantages.

The spot form the prior art laser collimator is spot light, which can not accurately indicate the object.

The switch must be pressed continuously. This will make the user feel ache and thus the work is affected. Especially as the laser collimator is used in a laser pen.

As the laser collimator is installed to a hat edge, the edge is buckled to a rod of the collimator so as to emit a laser beam. It is very possible that the switch is released due to the movement of the hat, and thus the laser collimator can not be work affectively.

### SUMMARY OF THE INVENTION

Accordingly, the primary object of the present invention is to provide a laser collimator for calibrating collimation of laser beams of a golf bar wherein the laser collimator comprises a discharge circuit including a capacitor and a resistor for controlling the discharging time; a switch; a digital circuit for generating preset and clearing actions so as to control the conduction and disconnection of current; the digital circuit being controlled by the switch; a boot type driving circuit for driving a following element; and a laser light emitter driven by the boot type driving circuit so as to illuminate.

Another object of the present invention is to provide a laser collimator for calibrating collimation of laser beams of a golf bar, wherein a transparent sheet is installed in front of the laser light emitting body. One surface of the transparent sheet is installed with a plurality of strips so that the laser beam from the laser light emitting body being as a straight beam. In using, as the switch is actuated, the laser light emitting body emits a straight beam for guiding a path of the golf ball so as to calibrate the pose of the user.

The various objects and advantages of the present invention will be more readily understood from the following detailed description when read in conjunction with the appended drawing.

### BRIEF DESCRIPTION OF THE DRAWINGS

FIG. 1 is a circuit diagram of a laser collimator used in a laser pen or a golf bar for calibrating the pose of the user.

FIG. 2 is a schematic view showing the operation of the prior art laser pen.

FIG. 3 is a schematic view installed the operation of the laser collimator of a prior art golf bar.

FIG. 4 shows the circuit of the present invention.

FIG. 5 is a schematic view showing the installation of the transparent sheet.

FIG. 6 is an enlarged view of the transparent sheet of the present invention.

FIG. 7 is a schematic view of one embodiment of the present invention.

FIG. 8 is a schematic view of another embodiment of the present invention.

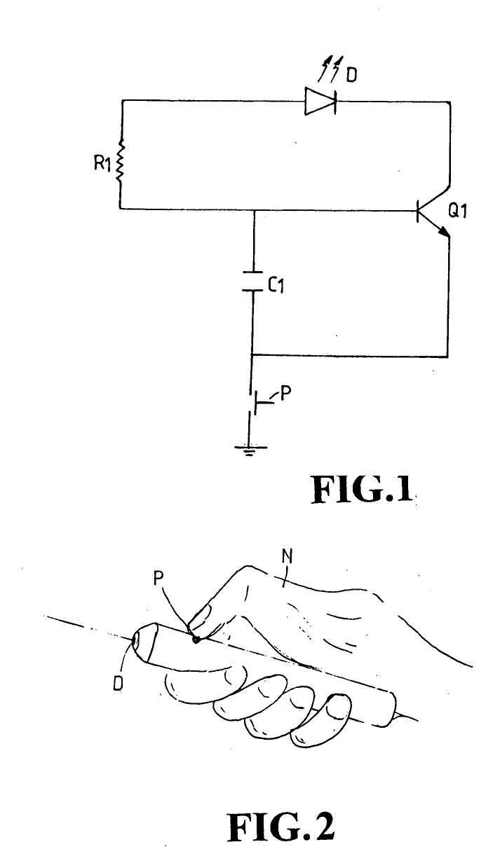

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

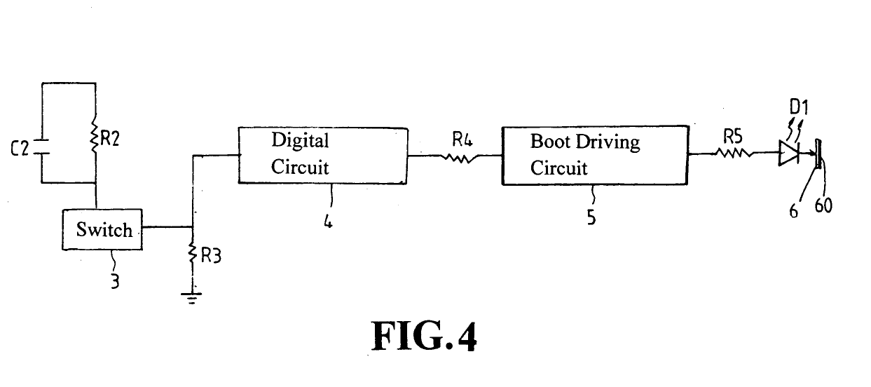

Referring to FIG. 4, the circuit of the present invention has the following elements.

A discharge circuit includes a capacitor 2 and a resistor R2 for controlling the discharging time.

A switch 3 is included.

A digital circuit 4 serves for generating preset or clearing actions so as to control the conduction and dis-connection of current. The digital circuit 4 is controlled by the switch 3.

A boot type driving circuit 5 serves for driving a following element.

A laser light emitter D1 is driven by the boot type driving circuit 5 so as to illuminate. A transparent sheet 6 is installed in front of the laser light emitting body D1. One surface of the transparent sheet 6 is installed with a plurality of strips 60, see FIG. 6, so that the laser beam from the laser light emitting body D1 is as a straight beam.

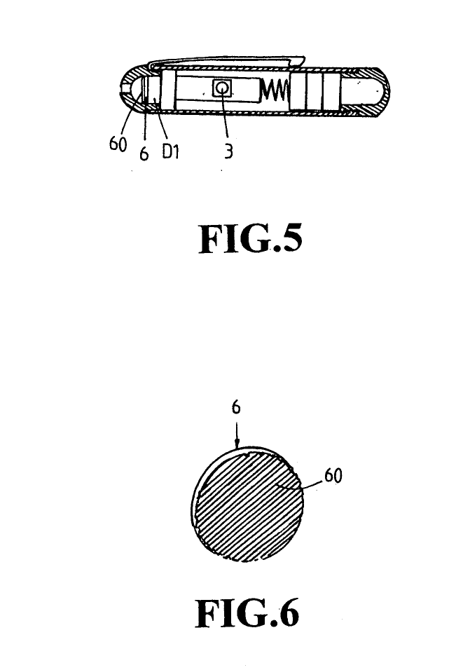

FIG. 5 shows the assembly view of the present invention.

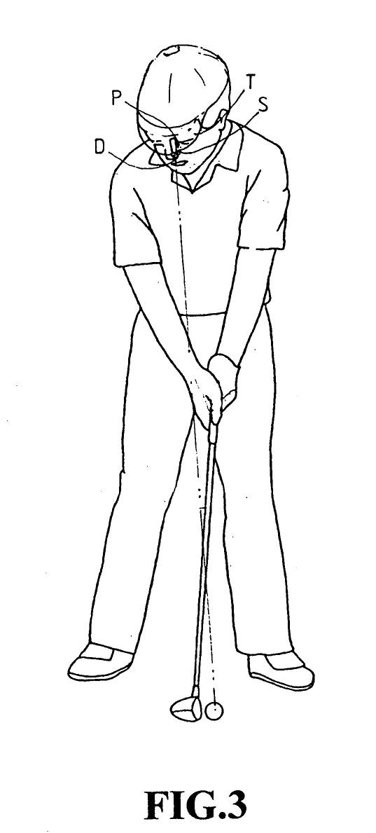

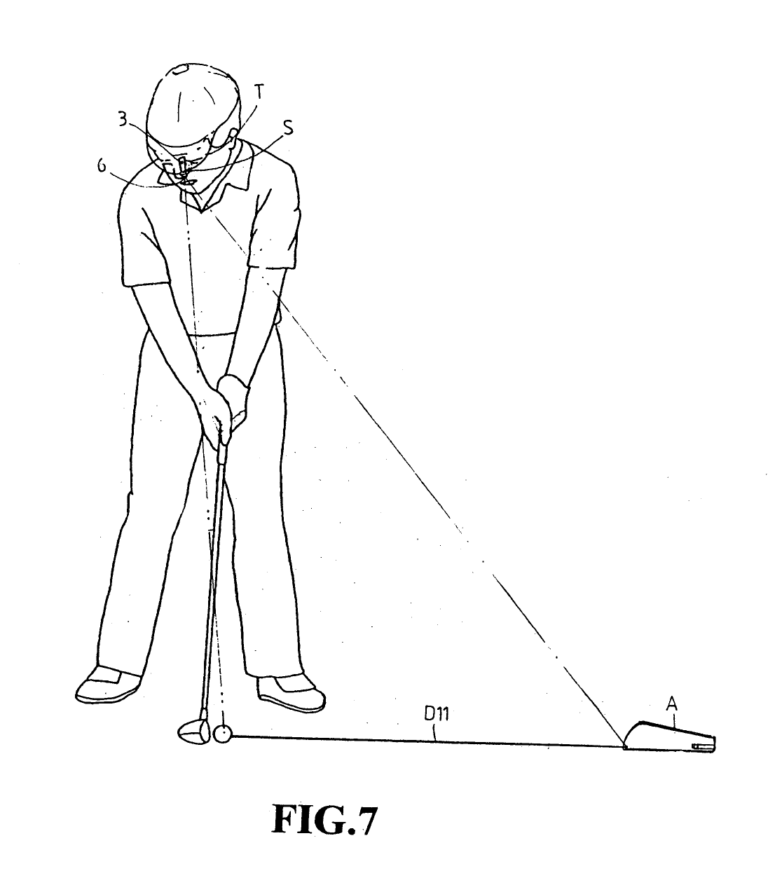

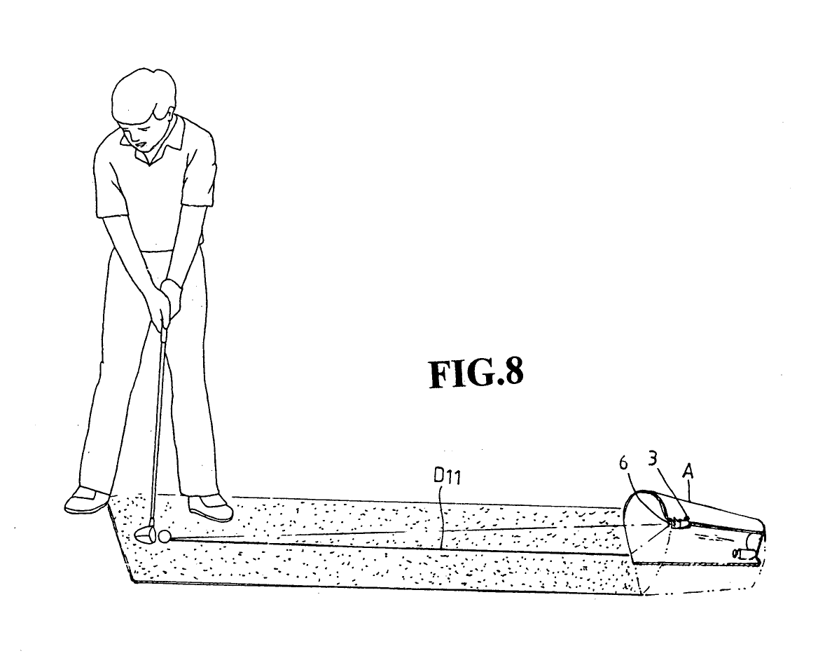

Referring to FIGS. 3, 7 and 8, the above laser collimator for calibrating collimation of laser beams of a golf bar of the present invention serves to be installed to a golf exerciser A or is placed at an edge of a hat T, see FIG. 3. In using, as the switch 3 is actuated, the laser light emitting body D1 emits a straight beam D11 for guiding a path of the golf ball so as to calibrate the pose of the user.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A laser collimator for calibrating collimation of laser beams of a golf bar comprising:
a discharge circuit including a capacitor and a resistor for controlling the discharging time;
a switch;
a digital circuit for generating preset and clearing actions so as to control the conduction and dis-connection of current; the digital circuit being controlled by the switch;
a boot type driving circuit for driving a following element; and
a laser light emitter driven by the boot type driving circuit so as to illuminate; a transparent sheet being installed in front of the laser light emitting body; one surface of the transparent sheet being installed with a plurality of strips so that the laser beam from the laser light emitting body being as a straight beam;
wherein in using, as the switch is actuated, the laser light emitting body emits a straight beam for guiding a path of the golf ball so as to calibrate the pose of the user.
